(19) United States
(12) Patent Application Publication
(10) Pub. No.: US 2014/0149624 A1
(43) Pub. Date: May 29, 2014

(54) Method for Determining a Serial Attached Small Computer System Interface Topology

(71) Applicant: LSI CORPORATION, Milpitas, CA (US)

(72) Inventors: Charles D. Henry, Wichita, KS (US); Luke E. McKay, Rose Hill, KS (US); Jason A. Unrein, Wichita, KS (US)

(73) Assignee: LSI Corporation, Milpitas, CA (US)

(21) Appl. No.: 13/688,280

(22) Filed: Nov. 29, 2012

(51) Int. Cl. G06F 13/40

(52) U.S. Cl. CPC G06F 13/40
USPC 710/305

(57) ABSTRACT

A method for determining a topology based on input/output criteria includes selecting a predefined topology, measuring the fitness of the topology, and breeding individuals from the topology by combining elements from the fittest individuals. The topology is then updated with the new individuals and the fitness of the new topology is measured. Iterations continue similarly until certain criteria are met.

### BACKGROUND OF THE INVENTION

Serial attached small computer system interface topologies are designed with limited data available. Determining a valid topology to meet certain requirements is slow, defies appropriate simulation, and is not necessarily straightforward.

Engineers designing topologies to meet certain requirements must do so with incomplete information. The only check for topology validity is during performance analysis. The solution will usually produce a workable topology but it might not be the best solution to meet all requirements. The design of a topology is limited by the engineer's ability to conceptualize all of the serial attached small computer system interface topology clearly.

Topology design decisions are made early in the development process, and cannot be checked until performance testing is accomplished. The optimal serial attached small computer system interface solution, given certain topology requirements, cannot be reliably found.

Consequently, it would be advantageous if an apparatus existed that is suitable for producing a serial attached small computer system interface topology to meet a given set of topology requirements.

### SUMMARY OF THE INVENTION

Accordingly, the present invention is directed to a novel method and apparatus for producing a serial attached small computer system interface topology to meet a given set of topology requirements.

One embodiment of the present invention is a method for implementing a genetic algorithm to determine a serial attached small computer system interface topology. In this embodiment, an initial serial attached small computer system interface topology population is generated and the fitness of the initial population is calculated based on the average time of each input/output. New individuals are “bred” based on characteristics of individuals in the initial population, and existing individuals are replaced with the new individuals to form a new population. The fitness of the new population is then calculated and compared to the fitness of the initial population. The process is repeated iteratively until termination criteria are met.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a block diagram of an expander suitable for implementing embodiments of the present invention;

FIG. 2 shows a flowchart of a method for producing a topology; and

FIG. 3 shows a block diagram of a computer system for implementing embodiments of the present invention.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

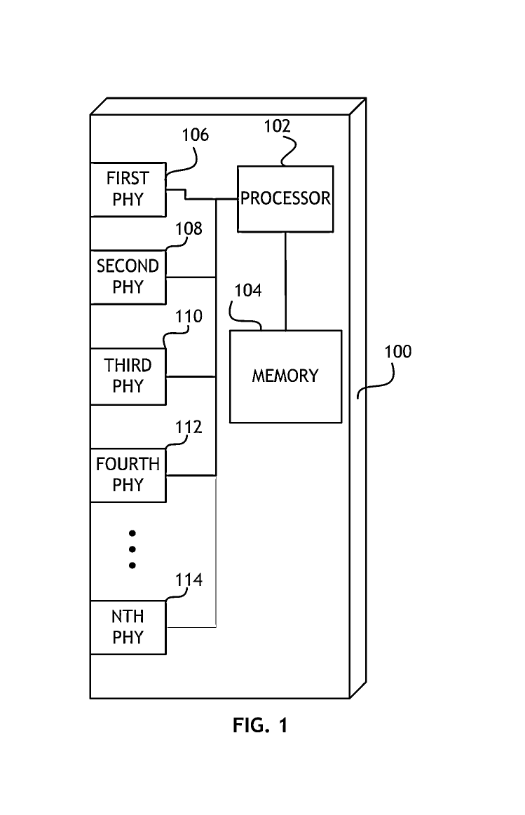

Referring to FIG. 1, a block diagram of an expander suitable for implementing embodiments of the present invention is shown. The expander 100 includes a processor 102, a plurality of PHYs 106, 108, 110, 112, 114 connected to the processor, and a memory 104 connected to the processor 102. The expander 100 is part of a serial attached small computer system interface topology produced by a method for iteratively updating a topology and testing the topology against certain requirements.

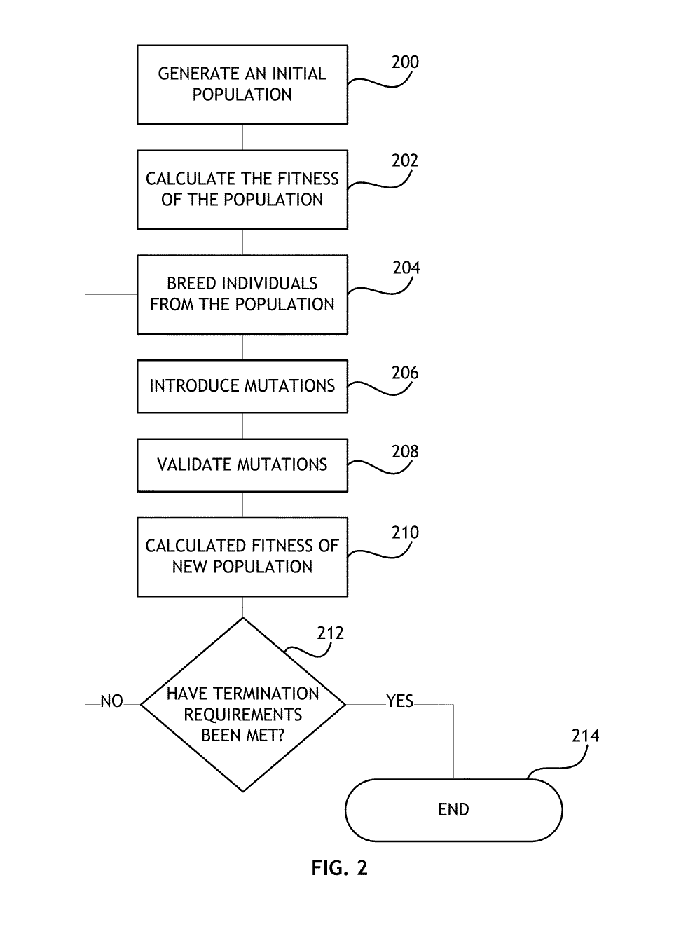

Referring to FIG. 2, a flowchart of a method for producing a topology through a genetic algorithm is shown. In at least one embodiment of the present invention, a computer system determining a serial attached small computer system interface topology generates an initial population 200. The initial population can be based on known topologies and can be selected from a group of known topologies based on given criteria such as a number of expanders. The initial population is a simulation of a topology including expanders, initiators, end devices and other valid device types. Devices are defined with certain initial characteristics such as number of PHYs. In at least one embodiment of the present invention, characteristics are defined in extensible markup language. In at least one embodiment of the present invention, topology requirements and fitness criteria are also defined in extensible markup language. In at least one embodiment of the present invention, desired input/output characteristics are defined in extensible markup language.

In at least one embodiment of the present invention, the defined characteristics of the topology include a list of PHYs that are not connected to anything. For each serial attached small computer system interface address there will be a type definition determining if it is an expander, initiator, or drive (target emulation or otherwise). Each PHY address definition will contain abilities fields that define speed and initiator/target capabilities. Each Expander definition structure will contain an array of PHYs, their capabilities, their connections, and total number of PHYs. Each initiator definition structure will contain an input/output pattern array list containing input/output definitions and percentage of total input/outputs. The input/output definitions will consist of direction (read/write), percentage and block size. Each target definition structure will contain the target capabilities and what the target is attached to.

The system calculates 202 the fitness of the initial population. Fitness is determined by an input/output simulation under normal conditions using input/output patterns given in the individual encoding. In at least one embodiment of the present invention, fitness is a measure of the average time of each input/output. In at least one embodiment of the present invention, fitness is measured for each individual in the topology. The fitness of each individual determines the probability of the individual being selected for the next generation. In the context of the present specification, “individual” should be understood to a serial attached small computer system interface (SAS) topology.

Individuals from the initial population are bred 204 to produce a new population. Breeding in the context of the present specification refers to combining features of individuals in the population to produce new individuals. New individuals replace individuals from the initial population having the least desirable characteristics. Breeding in the environment is not random, and usually occurs between two individuals of similar defined characteristics. In at least one embodiment of the present invention, breeding is restricted to two individuals of similar element structure.

In at least one embodiment of the present invention, during breeding, mutations are introduced 206 to randomize individual and topology characteristics. Mutation refers to modifications such as the number of PHYs in an individual, number of expanders in the topology and connections between individuals. Each individual definition contains an element, such a data bit, indicating whether an individual can be mutated. The mutation algorithm will skip over an individual with this element set.

In at least one embodiment of the present invention, mutations are validated 208. Mutation validation 208 can be implemented in two ways; throw out individuals with invalid mutations, or the mutation algorithm can be designed to never create invalid mutations based on accurately defined constraints. Constraints can be defined to apply to one or more individuals, or to the entire topology.

In at least one exemplary embodiment of the present invention, the number of expanders in a topology should not exceed a certain, defined number. Certain definitions, such as the defined input/output loads within each individual, will not be modified.

In at least one exemplary embodiment of the present invention, a computer system implementing embodiments of the present invention determines 212 if termination criteria have been met. In at least one embodiment of the present invention, termination criteria are based on the acceleration of fitness improvement. In at least one embodiment of the present invention, termination criteria are based on the top fitness of the topology over a predefined number of generations.

In this example, if termination criteria are not met, the computer system breeds 204 individuals from the new population and continues as described herein to produce a new generation of the topology. The process continues until the computer system determines 212 that termination criteria have been met, when the process ends 214. By these methods, a topology having desired fitness characteristics is produced.

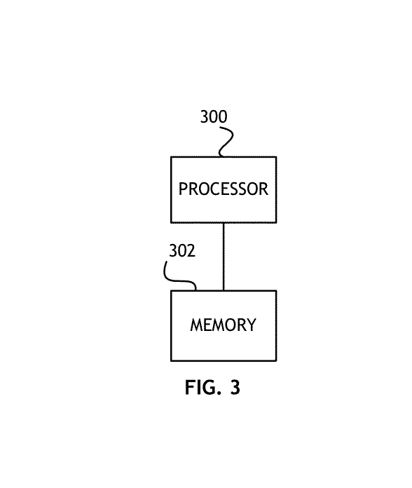

Referring to FIG. 3, a block diagram of a computer system for implementing embodiments of the present invention is shown. The system includes a processor 300 and a memory 302 connected to the processor 300. In at least one exemplary embodiment of the present invention, the processor 300 is configured to determine a topology for a serial attached small computer system interface network based on certain requirements.

In at least one exemplary embodiment of the present invention, the processor 300 is configured, through computer executable program code, to generate an initial population based on known topologies. In at least one exemplary embodiment of the present invention, individual element characteristics, topology requirements and fitness criteria are defined in extensible markup language and stored in the memory 302. In at least one embodiment of the present invention, desired input/output characteristics are defined in extensible markup language and stored in the memory 302.

In this example, the processor 300 calculates the fitness of the initial population. Fitness is determined by an input/output simulation under normal conditions using input/output patterns given in the individual encoding. In at least one embodiment of the present invention, fitness is a measure of the average time of each input/output. In at least one exemplary embodiment of the present invention, the processor 300 measures fitness for each individual in the topology. The fitness of each individual determines the probability of the individual being selected for the next generation.

In at least one exemplary embodiment of the present invention, the processor 300 breeds individuals from the initial population to produce a new population. Breeding in the context of the present specification refers to combining features of individuals in the population to produce new individuals. In this example, new individuals replace individuals from the initial population having the least desirable characteristics. Breeding in the environment is not random, and usually occurs between two individuals of similar defined characteristics. In at least one exemplary embodiment of the present invention, breeding is restricted to two individuals of similar element structure.

In at least one exemplary embodiment of the present invention, during breeding, the processor 300 introduces mutations to randomize individual and topology characteristics. Mutation refers to modifications such as the number of PHYs in an individual, number of expanders in the topology and connections between individuals. In at least one exemplary embodiment of the present invention, each individual definition contains an element, such a data bit, indicating whether an individual can be mutated. The processor 300 will skip over an individual with this element set.

In at least one exemplary embodiment of the present invention, the processor 300 validates mutations. Mutation validation can be implemented in two ways; the processor 300 throws out individuals with invalid mutations, or the processor 300 never creates invalid mutations based on accurately defined constraints. Constraints can be defined to apply to one or more individuals, or to the entire topology.

In at least one exemplary embodiment of the present invention, the number of expanders in a topology should not exceed a certain, defined number. Certain definitions, such as the defined input/output loads within each individual, will not be modified.

The processor 300 determines if termination criteria have been met. In at least one exemplary embodiment of the present invention, termination criteria are based on the acceleration of fitness improvement. In at least one exemplary embodiment of the present invention, termination criteria are based on the top fitness of the topology over a predefined number of generations.

If termination criteria are not met, the processor 300 breeds individuals from the new population and continues as described herein to produce a new generation of the topology. The process continues until the processor 300 determines that termination criteria have been met, when the process ends.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for determining a serial attached small computer system interface topology comprising:
generating an initial population;
calculating the fitness of the initial population;
breeding a new individual based on characteristics of two individuals in the initial population;
replacing an existing individual from the initial population with the new individual to produce a new population; and
calculating the fitness of the new population.

2. The method of claim 1, further comprising comparing the fitness of the initial population to the fitness of the new population.

3. The method of claim 1, further comprising:
iteratively breeding one or more new individuals from a preceding population to produce a subsequent population; and
comparing the fitness of the preceding population to the subsequent population.

4. The method of claim 3, further comprising determining, during each iteration, if one or more termination criteria have been met.

5. The method of claim 4, wherein the one or more termination criteria comprises a rate of change of fitness between preceding populations and subsequent populations.

6. The method of claim 4, wherein the one or more termination criteria comprises a number of iterations during which a maximum fitness does not improve.

7. The method of claim 1, wherein breeding comprises introducing one or more mutations, wherein the one or more mutations comprise random alterations to one or more characteristics of at least one individual.

8. The method of claim 7, wherein the one or more mutations are limited by one or more predefined constraints.

9. An apparatus for determining a serial attached small computer system interface topology comprising:
a processor;
a memory connected to the processor; and
computer executable program code configured to execute on the processor, wherein the computer executable program code is configured to:
generate an initial population;
calculate the fitness of the initial population;
breed a new individual based on characteristics of two individuals in the initial population;
replace an existing individual from the initial population with the new individual to produce a new population; and
calculate the fitness of the new population.

10. The apparatus of claim 9, wherein the computer executable program code is further configured to compare the fitness of the initial population to the fitness of the new population.

11. The apparatus of claim 9, wherein the computer executable program code is further configured to:
iteratively breed one or more new individuals from a preceding population to produce a subsequent population; and
compare the fitness of the preceding population to the subsequent population.

12. The apparatus of claim 11, wherein the computer executable program code is further configured to determine, during each iteration, if one or more termination criteria have been met.

13. The apparatus of claim 12, wherein the one or more termination criteria comprises a rate of change of fitness between preceding populations and subsequent populations.

14. The apparatus of claim 12, wherein the one or more termination criteria comprises a number of iterations during which a maximum fitness does not improve.

15. The apparatus of claim 9, wherein breeding comprises introducing one or more mutations, wherein the one or more mutations comprise random alterations to one or more characteristics of at least one individual.

16. The apparatus of claim 15, wherein the one or more mutations are limited by one or more predefined constraints.

17. An apparatus for simulating a serial attached small computer system interface topology comprising:
a processor;
a memory connected to the processor; and
computer executable program code configured to execute on the processor, wherein the computer executable program code is configured to:
calculate the fitness of an initial population based on at least one input/output criteria;
breed a new individual based on characteristics of two individuals in the initial population;
introduce mutations comprising random alterations to one or more characteristics of the new individual;
replace an existing individual from the initial population with the new individual to produce a new population; and
calculate the fitness of the new population based on the at least one input/output criteria,
wherein the mutations are limited by one or more predefined constraints.

18. The apparatus of claim 17, wherein the computer executable program code is further configured to:
iteratively breed one or more new individuals from a preceding population to produce a subsequent population;
compare the fitness of the preceding population to the subsequent population; and
determine, during each iteration, if one or more termination criteria have been met.

19. The apparatus of claim 18, wherein the one or more termination criteria comprises a rate of change of fitness between preceding populations and subsequent populations.

20. The apparatus of claim 18, wherein the one or more termination criteria comprises a number of iterations during which a maximum fitness does not improve.
